(19) United States
(12) Patent Application Publication
(10) Pub. No.: US 2024/0275563 A1
(43) Pub. Date: Aug. 15, 2024

(54) CONTROLLERS, COMMUNICATION SYSTEMS, CONTROL METHODS, AND PROGRAMS

(71) Applicant: NIPPON TELEGRAPH AND TELEPHONE CORPORATION, Tokyo (JP)

(72) Inventors: Yuki SAKAUE, Musashino-shi, Tokyo (JP); Katsuya MINAMI, Musashino-shi, Tokyo (JP); Tatsuya FUKUI, Musashino-shi, Tokyo (JP); Ryohei TSUGAMI, Musashino-shi, Tokyo (JP)

(73) Assignee: NIPPON TELEGRAPH AND TELEPHONE CORPORATION, Tokyo (JP)

(21) Appl. No.: 18/569,194

(22) PCT Filed: Jul. 2, 2021
(86) PCT No.: PCT/JP2021/025139

§ 371 Date: Dec. 11, 2023

(51) Int. Cl. H04L 5/00; H04W 72/541; H04W 74/0816

(52) U.S. Cl. CPC H04L 5/0073; H04W 72/541; H04W 74/0816

(57) ABSTRACT

To solve the above problem, the present invention aims to provide a controller, a communication system, a control method, and a program capable of performing transmission scheduling to avoid mutual interference in a plurality of wireless networks.

A controller 13 according to the present invention includes a scheduler SCH3 that calculates a transmission schedule for packets to be transmitted from buffers (FB1, FB2) on the basis of the amount of packets stored in a database DB in each predetermined period, and, when calculating the transmission schedule, imposes a restriction to prevent a total amount of packets to be transmitted from all the buffers (FB1, FB2) included in a network NW #j from exceeding the product of the throughput of each network NW #j and the predetermined period.

### TECHNICAL FIELD

The present disclosure relates to a controller, a communication system, a control method, and a program for controlling communication among a plurality of access networks.

### BACKGROUND ART

In recent years, studies have been made to accommodate a plurality of services and applications having various network requirements on the same network infrastructure. For this purpose, it is necessary to ensure quality required by each service and application accommodated in the same network (NW) in an end-end section of “terminal to terminal” or “terminal to application server”.

The end-end section of a network can be divided into wireless and wired sections. Among them, in the wireless section, there is a priority control function called Enhanced Distributed Channel Access (EDCA) of IEEE802.11 as an existing technology (see Non Patent Literatures 1 and 2, for example).

EDCA is control on a terminal (destination) basis, and it is difficult to perform control on a traffic flow basis to enable quality control on a service and application basis. However, by adopting the technology disclosed in Non Patent Literature 3, it is possible to perform quality control on a service and application basis.

### CITATION LIST

### Non Patent Literature

Non Patent Literature 1: IEEE 802.11e-2005—IEEE Standard for Information technology—Local and metropolitan area networks—Specific requirements—Part 11: Wireless LAN Medium Access Control (MAC) and Physical Layer (PHY) Specifications—Amendment 8: Medium Access Control (MAC) Quality of Service Enhancements
Non Patent Literature 2: “IEEE802.11e—QoS Enhanced Wireless LAN Standard”, The Journal of the Institute of Image Information and Television Engineers Vol. 57, No. 11 (2003)
Non Patent Literature 3: Yuki Sakaue, Kazuki Aiura, Tatsuya Fukui, et al.: “Proposal of Quality Control Technology Using Centralized Control Independent of Wireless Network”, The IEICE General Conference, Mar. 9, 2021 B-6-5

### SUMMARY OF INVENTION

### Technical Problem

By the transmission control technology disclosed in Non Patent Literature 3, a main signal between a terminal and an access point, and a control signal between a controller and the terminal and the access point are transmitted and received with another communication means. At present, however, there are terminals and access points that cannot easily use a plurality of wireless networks simultaneously (which means those terminals and access points transmit/receive a main signal and a control signal through different communication means), and the technology disclosed in Non Patent Literature 3 cannot be applied to such a communication system.

Furthermore, in a case where main signals and control signals are accommodated in the same wireless network, the communication system might not function due to collision between these signals. Specifically, as illustrated in FIG. 1, there are cases where a control signal interrupts when a main signal is to be transmitted at the timing indicated by a scheduler, and a packet cannot be transmitted according to a schedule. Conversely, there are cases where periodic communication cannot be performed due to a main signal for transmitting a packet according to a schedule when a control signal that is periodically communicated is to be transmitted. In such cases, correct scheduling and scheduler notification cannot be performed, and the communication system does not function.

That is, in a communication system in which main signals and control signals coexist in the same wireless network, it is not possible to control each traffic flow by the technology of Non Patent Literature 3, and it is difficult to perform quality control for each service and application.

Therefore, to solve the above problem, the present invention aims to provide a controller, a communication system, a control method, and a program capable of achieving quality control for each service or application even when main signals and control signals coexist in the same wireless network.

### Solution to Problem

To achieve the above objective, a controller according to the present invention gathers information from terminals and an access point included in a network, and calculates a schedule for transmitting main signals while avoiding periodic control signal transmission timings.

Specifically, a controller according to the present invention is a controller that controls traffic in a wireless network,
the wireless network including one access point and one or a plurality of terminals, a packet being transmitted as a main signal between the terminals and the access point, the controller including:
a transmitter/receiver that transmits/receives a control signal to/from the terminals or the access point, using the same frequency band of the wireless network as the main signal;
a database that stores the amount of packets accumulated in buffers for respective traffic flows, the buffers being included in the terminals and the access point, the amount of packets having been received as the control signal; and
a scheduler that calculates a transmission schedule of packets to be transmitted from the buffers on the basis of the amount of packets stored in the database in each scheduling period, imposes an upper limit restriction to prevent a total amount of packets to be transmitted from all the buffers included in the wireless network from exceeding the product of a throughput of the wireless network and the scheduling period and a period restriction to avoid the control signal transmission/reception periods, when calculating the transmission schedule, and notifies the terminals and the access point of the transmission schedule via the transmitter/receiver.

A control method according to the present invention is a control method for controlling traffic in a plurality of wireless networks,
the wireless networks including one access point and one or a plurality of terminals, a packet being transmitted as a main signal between the terminals and the access point, the control method including:
transmitting/receiving a control signal to/from the terminals or the access point, using the same frequency band of the wireless networks as the main signal;
storing, in a database, the amount of packets accumulated in buffers for respective traffic flows, the buffers being included in the terminals and the access point, the amount of packets having been received as the control signal;
calculating a transmission schedule of packets to be transmitted from the buffers on the basis of the amount of packets stored in the database in each scheduling period;
imposing an upper limit restriction to prevent a total amount of packets to be transmitted from all the buffers included in the wireless networks from exceeding the product of a throughput of the wireless networks and the scheduling period and a period restriction to avoid the control signal transmission/reception periods, when calculating the transmission schedule; and
notifying the terminals and the access point of the transmission schedule.

At the time of scheduling packet transmission timings, the controller recognizes the amounts of accumulated packets from all the terminals and the access points, imposes an upper limit to make the total packet transmission amount equal to or smaller than the product of the throughput and the schedule period, and a period restriction to avoid the control signal transmission/reception periods, and performs schedule calculation. With the restrictions, collision between a main signal and a control signal can be avoided. Thus, the present invention can provide a controller and a control method capable of achieving quality control for each service or application even when main signals and control signals coexist in the same wireless network.

The database can further store, for each of the terminal and the access point, a notification period for receiving the control signal from a past record of the transmitter/receiver receiving the control signal and a past record of the transmitter/receiver transmitting the control signal, and the scheduler can set the period restriction on the basis of the notification period.

The scheduler may set the notification period beforehand, notify the terminals and the access point of the notification period, and set the period restriction on the basis of the notification period.

Meanwhile, a communication system according to the present invention includes: the controller; and the wireless networks including the one access point and the one or a plurality of terminals.

Further, the present invention is a program for causing a computer to function as the controller. The controller of the present invention can also be implemented by a computer and a program, and the program can be recorded in a recording medium or be provided through a network.

Note that the inventions described above can be combined in any possible manner.

### Advantageous Effects of Invention

The present invention can provide a controller, a communication system, a control method, and a program capable of achieving quality control for each service or application even when main signals and control signals coexist in the same wireless network.

### BRIEF DESCRIPTION OF DRAWINGS

FIG. 1 is a diagram for explaining an objective of the present invention.

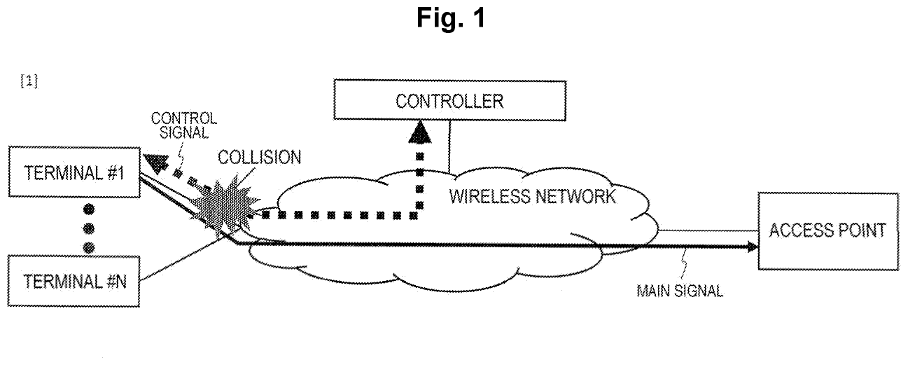

FIG. 2 is a diagram for explaining a communication system according to the present invention.

FIG. 3 is a table for explaining a database included in a controller according to the present invention.

FIG. 4 is a table for explaining a database included in the controller according to the present invention.

FIG. 5 is a diagram for explaining a control method according to the present invention.

FIG. 6 is a diagram for explaining a control method according to the present invention.

FIG. 7 is a diagram for explaining a control method according to the present invention.

FIG. 8 is a diagram for explaining a control method according to the present invention.

FIG. 9 is a diagram for explaining a communication system according to the present invention.

### DESCRIPTION OF EMBODIMENTS

Embodiments of the present invention are described with reference to the accompanying drawings. The embodiments described below are examples of the present invention, and the present invention is not limited to these embodiments. Note that components denoted by the same reference numerals in the present specification and the drawings are the same components.

### First Embodiment

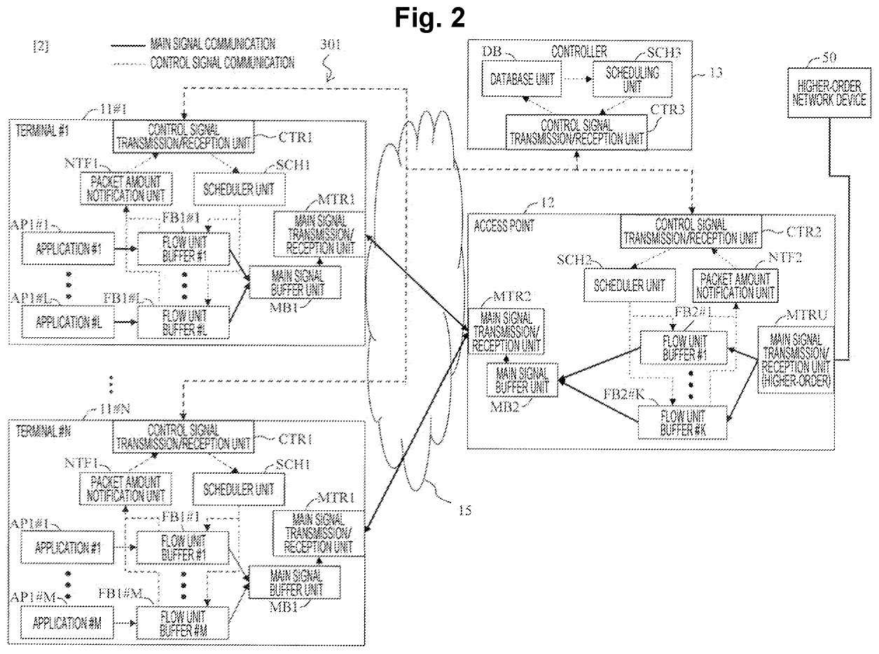

FIG. 2 is a diagram for explaining a communication system of this embodiment. This communication system includes a controller 13, and a network 15 having one access point 12 and one or a plurality of terminals 11. Main signals and control signals are communicated at the same frequency via the same wireless network.

The controller 13 is connected to each terminal 11 #n (n being a natural number up to N) and the access point 12, and no other network devices are present.

The controller 13 records, beforehand in a database unit DB, each terminal 11 #n to be connected, the access point 12, and the throughput of the network 15 to which those terminals and access point belong.

The controller 13 is connected to each terminal 11 and the access point 12.

Each terminal 11 and the access point 12 accumulate packets in buffers (flow unit buffers FB1, FB2) for respective traffic flows or buffers in applications, and notify the controller 13 of the amount of accumulated packets as a control signal in each predetermined period.

The controller also recognizes the transmission period of a control signal from each terminal 11 and the access point 12.

The controller 13 records each packet accumulation amount in the database unit DB as notified.

A scheduling unit SCH3 of the controller 13 determines a packet transmission schedule (a transmission time and a transmission amount for each traffic flow) of each flow unit buffer (FB1, FB2) on the basis of information in the database unit DB. At this point of time, the scheduling unit SCH3 performs calculation so that the total packet transmission amount according to the schedule does not exceed the product of the throughput and the predetermined period (a schedule period), which is the upper limit. The scheduling unit SCH3 also recognizes the communication duration of a control signal from the notification period, the notification start time, and the notification end time of each node in the database DB as a period restriction, and calculates the transmission schedule of a main signal so as to avoid the control signal. The scheduling will be described later in detail.

The controller 13 notifies each terminal 11 and the access point 12 of the determined transmission schedule.

Each terminal 11 and the access point 12 instruct each flow unit buffer (FB1, FB2) to transmit a packet, in accordance with the transmission schedule of which scheduler units (SCH1, SCH2) have been notified.

Each terminal 11 and the access point 12 transmit a packet via a main signal buffer unit (MB1, MB2) and a main signal transmission/reception unit (MTR1, MTR2).

Note that the times in the respective terminals 11, the respective access points 12, and the controller 13 are synchronized by a network time protocol (NTP), a precision time protocol (PTP), or the like.

Specifically, the controller 13 is a controller that controls traffic in the wireless network 15,
the wireless network 15 including one access point 12 and one or a plurality of terminals 11, a packet being transmitted as a main signal between the terminals 11 and the access point 12.

The controller 13 characteristically includes:
a transmitter/receiver CTR3 that transmits/receives a control signal to/from the terminals 11 or the access point 12, using the same frequency band of the wireless network 15 as the main signal;
a database DB that stores an amount of packets accumulated in buffers (FB1, FB2) for respective traffic flows, the buffers being included in the terminals 11 and the access point 12, the amount of packets having been received as the control signal; and
a scheduler SCH3 that calculates a transmission schedule of packets to be transmitted from the buffers (FB1, FB2) on the basis of the amount of packets stored in the database DB in each scheduling period, imposes an upper limit restriction to prevent a total amount of packets to be transmitted from all the buffers (FB1, FB2) included in the wireless network 15 from exceeding the product of the throughput of the wireless network 15 and the scheduling period and a period restriction to avoid the control signal transmission/reception periods, when calculating the transmission schedule, and notifies the terminals 11 and the access point 12 of the transmission schedule via the transmitter/receiver CTR3.

The communication system communicates a control signal between the controller 13 and the access point 12/terminals 11, using the same communication means as the communication means for a main signal (a packet of traffic). Specifically, control signals are transmitted and received between a control signal transmission/reception unit CTR1 of each terminal 11 and a control signal transmission/reception unit CTR3 of the controller 13, and between a control signal transmission/reception unit CTR2 of the access point 12 and the control signal transmission/reception unit CTR3 of the controller 13.

Each terminal 11 and the access point 12 periodically (in each notification period) notify the controller 13 of the amount of packets accumulated in the flow unit buffers (FB1, FB2) as a control signal.

Each terminal 11 accumulates packets from each application AP1 in buffers (FB1 #1 to FB1 #L/FB1 #M) for each application (for each flow). A packet amount notification unit NTF1 periodically checks the packet accumulation amount in each of the buffers (FB1 #1 to FB1 #L/FB1 #M), and notifies the controller 13 of the amount as a control signal via the control signal transmission/reception unit CTR1.

Also, each access point 12 accumulates packets from a higher-order network device 50 in buffers (FB2 #1 to FB2 #K) for each application (for each flow). A packet amount notification unit NTF2 periodically checks the packet accumulation amount in each of the buffers (FB2 #1 to FB2 #K), and notifies the controller 13 of the amount as a control signal via the control signal transmission/reception unit CTR2.

Note that the respective flow unit buffers FB1 may be owned by the applications AP1.

The controller 13 records information about the packet accumulation amount of which the controller 13 has been notified, the terminals 11, the access points 12, and the flow unit buffers (FB1, FB2), determines the transmission schedule (the transmission time and the transmission amount) for each buffer on the basis of the information, and notifies each terminal 11 and the access point 12 of the transmission schedule as a control signal.

The control signal transmission/reception unit CTR3 of the controller 13 receives control signals from each terminal 11 and the access point 12, and organizes the information about the packet accumulation amount, the terminals 11, the access points 12, and the flow unit buffers (FB1, FB2) included in the control signals in the database DB.

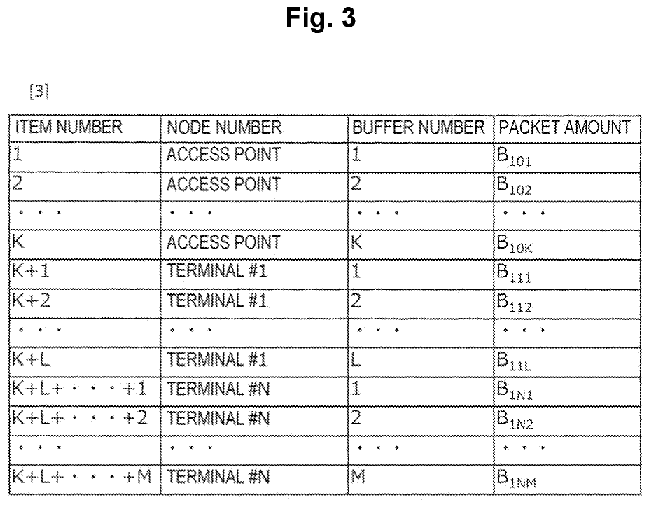

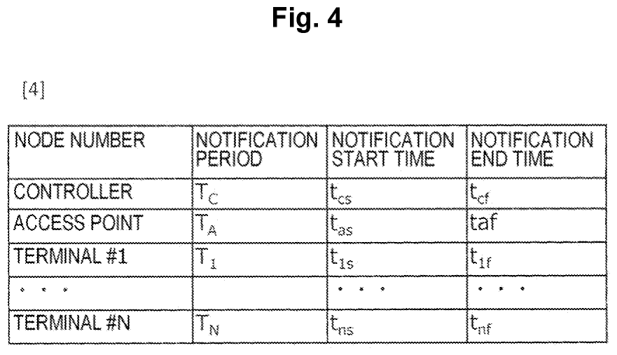

FIGS. 3 and 4 are tables for explaining an example of the information organized in the database DB. The database DB organizes the following three kinds of information in a first information section (see FIG. 3).
Item numbers: the serial numbers assigned to all the buffers (FB1, FB2) of the terminals 11 and the access points 12.
Node numbers: the numbers n assigned to the access point 12 or the terminals 11.
Buffer numbers: the numbers assigned to the buffers FB1 held by the respective terminals 11 or the numbers assigned to the buffers FB2 held by the access point 12.
Packet amounts: the amounts of packets accumulated in the buffers having the respective buffer numbers.

For example, the item number K+2 indicates the packet accumulation amount in the flow unit buffer FB1 #2 in the terminal 11 #1 belonging to the wireless network 15, meaning that the amount is “B112”.

The database DB organizes the following three kinds of information in a second information section (see FIG. 4).
Node numbers: the numbers n assigned to the access point 12 or the terminals 11.
Notification period: the period in which a control signal (a transmission schedule, for example) is transmitted from the controller 13 to each terminal 11, or the period in which a control signal (a packet accumulation amount, for example) is transmitted from each terminal 11 to the controller 13.
Notification start time: the time at which the access point 12 or the terminals 11 start transmitting a control signal.
Notification end time: the time at which the access point 12 or the terminals 11 end transmitting the control signal.

The scheduling unit SCH3 of the controller 13 determines the transmission schedule (the transmission time and the transmission amount) for each buffer from the contents of the database unit DB, using the scheduling method described later. The scheduling unit SCH3 then uses the determined transmission schedule as a control signal, and transmits the control signal to the terminals 11 and the access points 12 from the control signal transmission/reception unit CTR3.

Each terminal 11 and the access point 12 extract the packets accumulated in the flow unit buffers (FB1, FB2) at the transmission time and with the transmission amount in the transmission schedule in the notification, and inputs the packets to the main signal buffer units (MB1, MB2). The main signal transmission/reception units (MTR1, MTR2) transmit the packets in the main signal buffer units (MB1, MB2) to a wireless network 15.

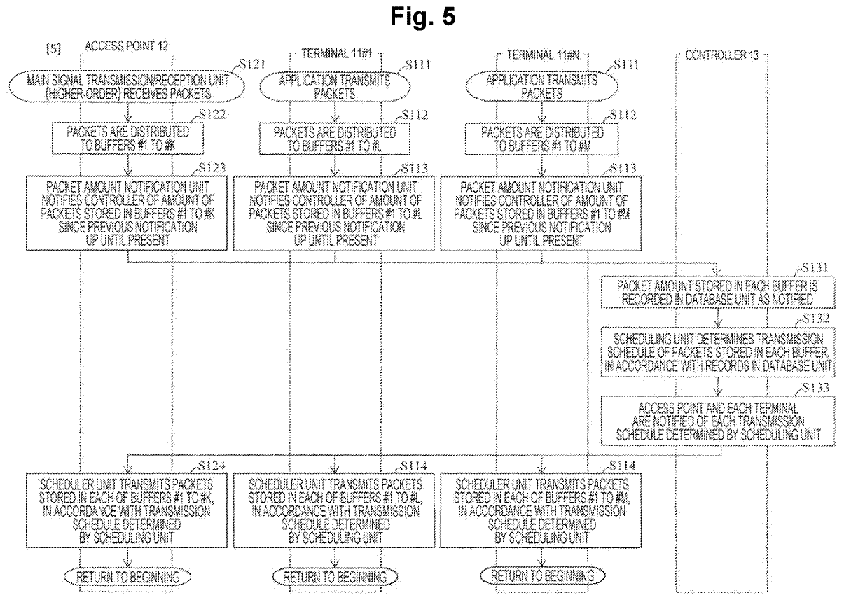

FIG. 5 is a diagram for explaining the above operation with a flowchart. A control method according to this embodiment is transmission control to be performed by the controller 13 on each terminal 11 and the access point 12 that mutually transmit packets via the respective wireless network 15,
the control method including:
accumulating transmission packets for each traffic flow in the respective buffers (FB1, FB2) of each terminal 11 and the access point 12 (steps S111, S112, S121, and S122);
transmitting the accumulation amount of the transmission packets for each traffic flow accumulated in each of the buffers to the controller 13 (steps S113 and S123);
determining, by the controller 13, a transmission schedule of the transmission packet for each traffic flow on the basis of the accumulation amount received from each of the terminals 11 and the access point 12 (steps S131 and S132);
transmitting the transmission schedule from the controller 13 to each of the terminals 11 and the access point 12 (step S133); and
transmitting the transmission packet for each traffic flow from the respective buffers (FB1, FB2) of the terminals 11 and the access point 12 to the wireless network 15 in accordance with the transmission schedule (steps S114 and S124).

However, certain restrictions (an upper limit restriction and a period restriction) described later are imposed when the transmission schedule is determined.

### [Scheduling Method]

The scheduling method implemented by the scheduling unit SCH3 of the controller 13 is now described. Although the scheduling method may be any method, the scheduling method disclosed in Non Patent Literature 3 is explained herein.

### [1] Fair Scheduling

By this scheduling method, a bandwidth or time is divided by the total number of flow unit buffers in which packets are accumulated among the flow unit buffers (FB1, FB2) of the terminals 11 and the access points 12.

The parameters are described below.
Combined number of flow unit buffers in which packets are accumulated in the terminals 11 and the access points 12: n
Duration of one cycle: T [sec]
Total main signal transmission limit per cycle time: Z [Bytes/sec]
Time to transmit first accumulated packet: tₛₜₐᵣₜ [sec]

In this case,
the transmission amount S_{J} [Bytes] of the flow unit buffer #J is calculated as follows.

$$[ Math . 1 ]$$

$${S}_{J} = \frac{Z}{n} \qquad ( 1 )$$

The transmission duration T_{J} [sec] of the flow unit buffer #J is calculated as follows.

$$[ Math . 2 ]$$

$${T}_{J} = \frac{T}{n} \qquad ( 2 )$$

The transmission time t_{J} [sec] of the flow unit buffer #J is calculated as follows.

$$[ Math . 3 ]$$

$${t}_{J} = {t}_{start} + {\sum }_{J = 1} {T}_{J - 1} \qquad ( 3 )$$

Note that it is conceivable that the order of the flow unit buffers to start transmission is the ascending order of item numbers organized in the database unit DB of the controller 13, for example.

[2] Scheduling with Band Weighting Taken into Consideration

This scheduling method is determined by the number of flow unit buffers in which packets are accumulated among the flow unit buffers (FB1, FB2) of the terminals 11 and the access points 12, and the packet accumulation amounts.

The parameters are described below.
Packet accumulation amount of the flow unit buffer #J: B_{J} [Bytes]
Duration of one cycle: T [sec]
Transmission limit per cycle time: Z [Bytes/sec]
Time required to transmit all packets accumulated in all flow unit buffers: Tₐₗₗ [sec]
Time to perform first packet transmission among packets accumulated in all flow unit buffers: tₛₜₐᵣₜ [sec]

In this case, calculation is performed as follows.

When it is defined as

$$[ Math . 4 ]$$

$${T}_{all} = \frac{{\sum }_{J = 1} {B}_{J}}{Z} , \qquad ( 4 )$$

the transmission amount S_{J} [Bytes] of the flow unit buffer #J is calculated as

$$[ Math . 5 a ]$$

$${S}_{J} = {B}_{J} \qquad ( 5 a )$$

in a case where Tₐₗₗ≤T,
and,

$$[ Math . 5 b ]$$

$${S}_{J} = \frac{T}{{T}_{all}} {B}_{J} \qquad ( 5 b )$$

in a case where Tₐₗₗ>T.

The transmission duration T_{J} [sec] of the flow unit buffer #J is calculated as

$$[ Math . 6 a ]$$

$${T}_{J} = \frac{{S}_{J}}{{\sum }_{J = 1} {B}_{J}} {T}_{all} \qquad ( 6 a )$$

in a case where Tₐₗₗ≤T,
and

$$[ Math . 6 b ]$$

$${T}_{J} = \frac{{S}_{J}}{{\sum }_{J = 1} {B}_{J}} {T}_{all} \qquad ( 6 b )$$

in a case where Tₐₗₗ>T.
The transmission time t_{J} [sec] of the flow unit buffer #J is calculated as

$$[ Math . 7 a ]$$

$${t}_{J} = {t}_{start} + {\sum }_{J = 1} {T}_{J - 1} \qquad ( 7 a )$$

in a case where Tₐₗₗ≤T,
and

$$[ Math . 7 b ]$$

$${t}_{J} = {t}_{start} + {\sum }_{J = 1} {T}_{J - 1} \qquad ( 7 b )$$

in a case where Tₐₗₗ>T.

Note that, in a case where Tₐₗₗ>T, packets that cannot be transmitted are carried over to the next transmission timing.

### [Upper Limit Restriction]

The upper limit restriction to be imposed in the schedule calculation to be performed by the scheduling unit SCH13 of the controller 13 is now described.

The packet amount to be transmitted from each flow unit buffer (FB1, FB2) as a result of scheduling is represented by pᵢ. At this point of time, the total amount of packets P to be transmitted in a scheduling period T can be expressed as follows.

$$[ Math . A1 ]$$

$$P = {\sum }_{i = 1} {p}_{i} \qquad ( A1 )$$

Further, the throughput of the wireless network 15 is a throughput TP. The controller 13 calculates the transmission schedule so that the following relationship always holds for any wireless network 15.

$$[ Math . A 2 ]$$

$$T \times TP \geq P$$

### [Period Restriction]

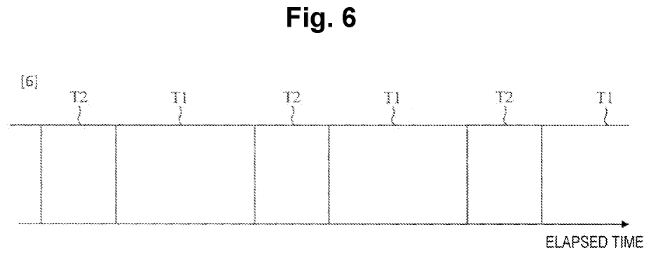

A period restriction is the restriction to be imposed to avoid transmission of a main signal during the transmission/reception period of a control signal, to avoid collision between the main signal and the control signal in the wireless network 15. For example, as illustrated in FIG. 6, time is divided into main signal transmission periods T1 and control signal notification periods T2.

### Example 1

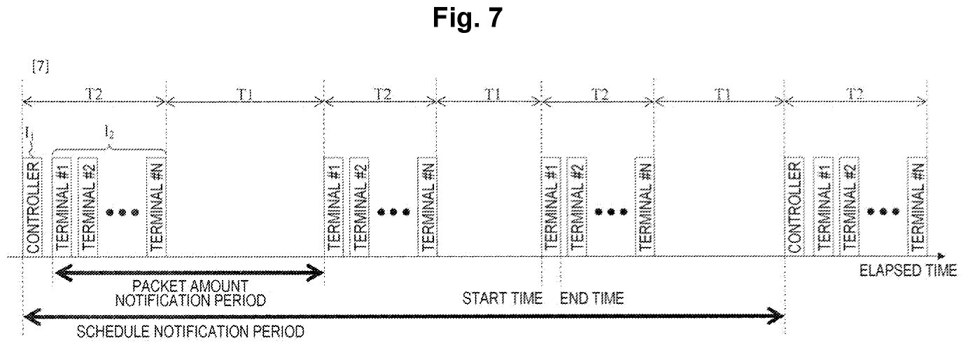

FIG. 7 is a diagram for explaining this example.

In this example, the database DB further stores, for each of the terminals 11 and the access point 12, a notification period during which control signals are received from a past record of the transmitter/receiver CTR3 receiving control signals (packet accumulation amounts sent as notifications from the terminals 11 and the access point 12) and a past record of the transmitter/receiver CTR3 transmitting control signals (transmission schedules of which the terminals 11 and the access point 12 are notified) (see FIG. 4), and
the scheduler SCH3 sets the period restriction on the basis of the notification period.

In FIG. 7, the abscissa axis indicates elapsed time, each box of “controller” indicates a control signal I₁ for notifying a terminal 11 or the access point 12 of a transmission schedule or the like from the controller 13, and each box of “terminal #n” indicates a control signal I₂ for notifying the controller 13 of a packet accumulation amount or the like from a terminal 11 or the access point 12. The left end of each control signal indicates the transmission start time, and the right end indicates the transmission end time. Further, a period in which a control signal I₁ is transmitted is a “schedule notification period”, which is a scheduling period. During a schedule notification period, a control signal I₂ is transmitted from each terminal 11 a plurality of times. This period is a “packet amount notification period”.

A period of a control signal I₁ and control signals I₂ is a control signal notification period T2, and a period between control signal notification periods T2 is a main signal transmission period T1.

The controller 13 learns the reception cycles of control signals I₂ from each terminal 11 and the access point 12 connected thereto, and records the reception cycles in the database DB. Specifically, the database DB checks the packet amount notification period, the start time, and the end time of each terminal 11 and the access point 12 a certain number of times, and records the average values of the respective items as illustrated in FIG. 4. Note that the control signals I₁ to be transmitted from the controller 13 to each terminal 11 and the access point 12 can be set by the controller 13, and therefore, the set values are written in the database DB.

The scheduler SCH3 sets the control signal notification periods T2 as the period restriction on the basis of the information in FIG. 4, and calculates the transmission schedule, with the upper limit restriction also being taken into consideration.

### Example 2

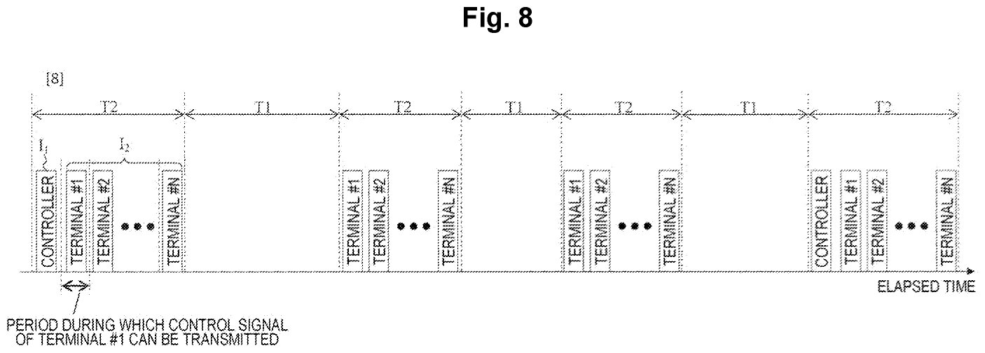

FIG. 8 is a diagram for explaining this example. The abscissa axis and the boxes in FIG. 8 have the same meanings as those in FIG. 7.

In this example, the scheduler SCH3 sets the notification period beforehand, notifies the terminals 11 and the access point 12 of the notification period, and sets the period restriction on the basis of the notification period.

The scheduler SCH3 sets a transmission allowed duration (a notification period, a notification start time, and a notification end time) during which control signals I₂ such as a packet accumulation amount can be transmitted, records the transmission allowed duration in the database DB as illustrated in FIG. 4, and notifies each terminal 11 and the access point 12 of the transmission allowed duration beforehand. As for the control signals I₁ to be transmitted from the controller 13 to each terminal 11 and the access point 12, set values that are set by the controller 13 are written in the database DB.

Each terminal 11 and the access point 12 transmit control signals I₂ at the notification start times indicated by the control signals I₁. The scheduler SCH3 sets the control signal notification periods T2 as the period restriction on the basis of the information in FIG. 4, and calculates the transmission schedule, with the upper limit restriction also being taken into consideration.

### Second Embodiment

The controller 13 can also be formed with a computer and a program, and the program can be recorded in a recording medium or be provided through a network.

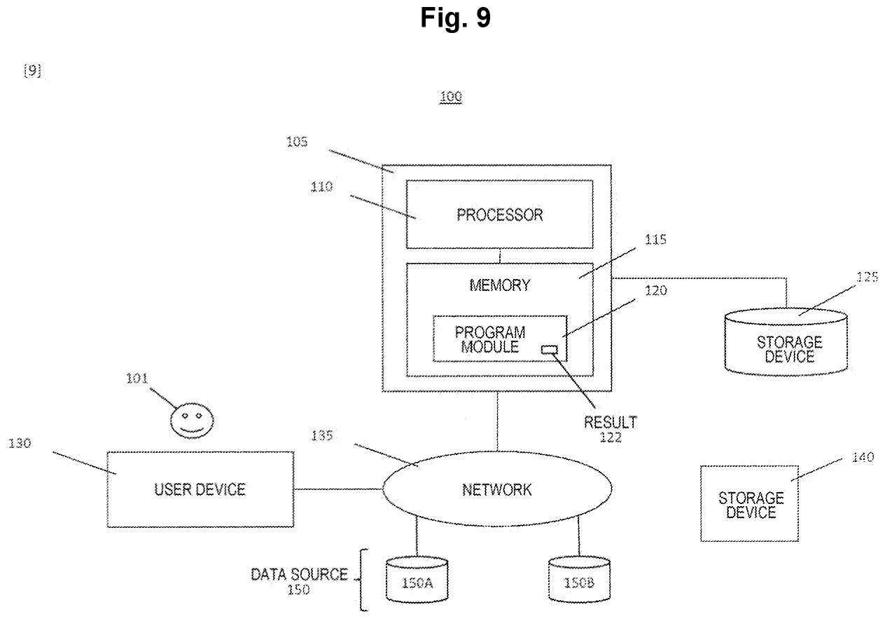

FIG. 9 illustrates a block diagram of a system 100. The system 100 includes a computer 105 connected to a network 135.

The network 135 is a data communication network. The network 135 may be a private network or a public network, and may include any or all of: (a) a personal area network that covers a room, for example; (b) a local area network that covers a building, for example; (c) a campus area network that covers a campus, for example; (d) a metropolitan area network that covers a city, for example; (e) a wide area network that covers areas connected across boundaries of cities, rural areas, or countries, for example; and (f) the Internet. Communication is performed with electronic signals and optical signals via the network 135.

The computer 105 includes a processor 110, and a memory 115 connected to the processor 110. In the present specification, the computer 105 is described as a standalone device. However, the computer is not limited to such a device, and may be connected to some other device (not shown in the drawing) in a distributed processing system.

The processor 110 is an electronic device including logic circuitry that responds to and executes instructions.

The memory 115 is a tangible computer-readable storage medium in which a computer program is encoded. In this regard, the memory 115 stores data and instructions, or program codes, that are readable and executable by the processor 110 to control operations of the processor 110. The memory 115 can be formed with a random access memory (RAM), a hard drive, a read-only memory (ROM), or a combination thereof. One of the components of the memory 115 is a program module 120.

The program module 120 includes instructions for controlling the processor 110 to perform processes described in the present specification. Although operations are performed by the computer 105, a method, a process, or a sub-process thereof in the present specification, those operations are actually performed by the processor 110.

In the present specification, the term “module” is used to refer to a functional operation that may be embodied either as a standalone component or as an integrated configuration of a plurality of sub-components. Accordingly, the program module 120 can be formed as a single module or as a plurality of modules that operate in cooperation with each other. Further, although the program module 120 is described as being installed in the memory 115 and thus being implemented in software in the present specification, the program module 120 can be implemented in hardware (an electronic circuit, for example), firmware, software, or a combination thereof.

Although the program module 120 has already been loaded into the memory 115 in the drawing, the program module 120 may be designed to be provided in a storage device 140 so as to be loaded later into the memory 115. The storage device 140 is a tangible computer-readable storage medium that stores the program module 120. Examples of the storage device 140 include a compact disk, a magnetic tape, a read-only memory, an optical storage medium, a memory unit formed with a hard drive or a plurality of parallel hard drives, and a universal serial bus (USB) flash drive. Alternatively, the storage device 140 may be a random access memory, or some other type of electronic storage device that is provided in a remote storage system (not illustrated) and is connected to the computer 105 via the network 135.

The system 100 further includes a data source 150A and a data source 150B that are collectively referred to as a data source 150 herein, and are communicatively connected to the network 135. In practice, the data source 150 may include any number of data sources, or one or more data sources. The data source 150 may include unstructured data, and may include social media.

The system 100 further includes a user device 130 that is operated by a user 101 and is connected to the computer 105 via the network 135. Examples of the user device 130 include an input device, such as a keyboard or a voice recognition subsystem, for enabling the user 101 to input information and command selections to the processor 110. The user device 130 further includes an output device such as a display device, a printer, or a speech synthesizer. A cursor control unit such as a mouse, a trackball, or a touch-sensitive screen allows the user 101 to manipulate a cursor on the display device to input further information and command selections to the processor 110.

The processor 110 outputs a result 122 of execution of the program module 120 to the user device 130. Alternatively, the processor 110 can provide an output to a storage device 125 such as a database or a memory, or to a remote device (not illustrated) via the network 135.

For example, a program for carrying out steps S131 to S133 in the flowchart in FIG. 3 may be used as the program module 120. The system 100 can be operated as the controller 13.

The term “include . . . ” or “including . . . ” specifies that the mentioned features, integers, steps, or components are present, but should be understood as not excluding the presence of one or more other features, integers, steps, or components, or groups thereof. The terms “a” and “an” are indefinite articles for an object, and therefore, do not exclude embodiments including a plurality of objects.

### OTHER EMBODIMENTS

Note that the present invention is not limited to the above embodiments, and various modifications can be made without departing from the scope of the invention. In short, the present invention is not limited to the specific embodiments, and in the implementation stage, the components may be modified and embodied without departing from the scope of the present invention.

Also, various inventions can be made by appropriately combining a plurality of components disclosed in the above embodiments. For example, some components may be deleted from all the components illustrated in the embodiments. Further, components in different embodiments may be combined as appropriate.

### REFERENCE SIGNS LIST

11, 11 #1, 11 #2 terminal
12, 12 #1, 12 #2 access point
13 controller
NW #j wireless network
50, 50 #1, 50 #2 higher-order network device
100 system
101 user
105 computer
110 processor
115 memory
120 program module
122 result
125 storage device
130 user device
135 network
140 storage device
150 data source
301 control system

1. A controller that controls traffic in a wireless network,
the wireless network including one access point and one or a plurality of terminals, a packet being transmitted as a main signal between the terminals and the access point, the controller comprising:
a transmitter/receiver that transmits/receives a control signal to/from the terminals or the access point, using the same frequency band of the wireless network as the main signal;
a database that stores an amount of packets accumulated in buffers for respective traffic flows, the buffers being included in the terminals and the access point, the amount of packets having been received as the control signal; and
a scheduler that calculates a transmission schedule of packets to be transmitted from the buffers on the basis of the amount of packets stored in the database in each scheduling period, imposes an upper limit restriction to prevent a total amount of packets to be transmitted from all the buffers included in the wireless network from exceeding a product of a throughput of the wireless network and the scheduling period and a period restriction to avoid the control signal transmission/reception periods, when calculating the transmission schedule, and notifies the terminals and the access point of the transmission schedule via the transmitter/receiver.

2. The controller according to claim 1, wherein
the database
further stores, for each of the terminal and the access point, a notification period for receiving the control signal from a past record of the transmitter/receiver receiving the control signal and a past record of the transmitter/receiver transmitting the control signal, and
the scheduler sets the period restriction on the basis of the notification period.

3. The controller according to claim 1, wherein
the scheduler
sets the notification period beforehand, notifies the terminals and the access point of the notification period, and sets the period restriction on the basis of the notification period.

4. A communication system comprising:
the controller according to claim 1; and
the wireless network including the one access point and the one or a plurality of terminals.

5. A control method for controlling traffic in a plurality of wireless networks,
the wireless networks including one access point and one or a plurality of terminals, a packet being transmitted as a main signal between the terminals and the access point, the control method comprising:
transmitting/receiving a control signal to/from the terminals or the access point, using the same frequency band of the wireless networks as the main signal;
storing, in a database, an amount of packets accumulated in buffers for respective traffic flows, the buffers being included in the terminals and the access point, the amount of packets having been received as the control signal;
calculating a transmission schedule of packets to be transmitted from the buffers on the basis of the amount of packets stored in the database in each scheduling period;
imposing an upper limit restriction to prevent a total amount of packets to be transmitted from all the buffers included in the wireless networks from exceeding a product of a throughput of the wireless networks and the scheduling period and a period restriction to avoid the control signal transmission/reception periods, when calculating the transmission schedule; and
notifying the terminals and the access point of the transmission schedule.

6. A non-transitory computer-readable medium having computer-executable instructions that, upon execution of the instructions by a processor of a computer, cause the computer to function as the controller according to claim 1.
